(19) United States
(12) Patent Application Publication
(10) Pub. No.: US 2016/0034515 A1
(43) Pub. Date: Feb. 4, 2016

(54) Assessing Risk of Inaccuracies in Address Components of Map Features

(71) Applicants: Lalitesh Katragadda, Bangalore (IN); Vinay Chitlangia, Bangalore (IN); Mandayam Thondanur Raghunath, Bangalore (IN); Anand Srinivasan, Bangalore (IN); Lakshminath Bhuvanagiri, Bangalore (IN)

(72) Inventors: Lalitesh Katragadda, Bangalore (IN); Vinay Chitlangia, Bangalore (IN); Mandayam Thondanur Raghunath, Bangalore (IN); Anand Srinivasan, Bangalore (IN); Lakshminath Bhuvanagiri, Bangalore (IN)

(73) Assignee: GOOGLE INC., Mountain View, CA (US)

(21) Appl. No.: 13/445,790

(22) Filed: Apr. 12, 2012

(51) Int. Cl. G06F 3/048

(52) U.S. Cl. CPC G06F 17/30371; G06F 17/30259; G06F 17/30241

(57) ABSTRACT

To generate address components for a selected map feature, all polygonal map features containing or near the location of a selected map feature are identified. The error bounds of each identified polygon are modeled based on the quality of the boundary of the polygon. Then, the error bounds of the polygon are compared to the location of the selected map feature to determine the strength of the match. The address components corresponding to the identified polygons are suggested to be components of the address of the selected map feature based on the strength of the matches. In another embodiment, a risk of inaccuracy of a combination of address components in an edited map feature is determined from comparison to other map data and can be adjusted based in part on the magnitude of an inconsistency between address components.

### CROSS-REFERENCE TO RELATED APPLICATION

This application is related to U.S. patent application Ser. No. 13/252,046, entitled “Semi-Automated Generation of Address Components of Map Features,” filed Oct. 3, 2011, the contents of which are incorporated by reference herein in their entirety.

### BACKGROUND

1. Field of the Invention

This invention generally relates to the generation of addresses of map features, and specifically relates to assessing the risk of inaccuracies in address components for user-generated edits and additions to map data.

2. Description of the Related Art

Conventionally, acquiring the data necessary to create a map requires vast amounts of time and resources. The data required to create a map (‘map data”) includes geographic data, such as latitude, longitude, elevation, and location of geographic features (e.g., bodies of water, mountains, forests); political data such as country, state, and city boundaries; location of roads and points of interest (e.g., government buildings, universities, stadiums); address numbering on streets; and attributes of map features, such as whether an area is public and the nature of the surface of a street. Acquiring the details of this data traditionally required integrating multiple different data sources, and even sending expert observers to the location to be mapped. This map making process is typically performed by company which has complete quality control over the data being added to the map, thereby preventing errors in the map data.

Recent advances in mapping technology have allowed users from around the world to contribute their local knowledge to mapping databases and to participate in editing map data. One example of such technology is Google Map Maker, available at http://google.com/mapmaker, developed by Google Inc.

Because individual contributors to map data can operate largely independently of the map provider, there is a greater likelihood for errors to arise in the map data. First, there is the potential that the data entered by one user for a feature may duplicate (i.e., completely or partially overlap) the data entered for the same feature by one or more other users. Second, the quality of the data entered by various users may vary widely. Accordingly, it can be difficult to assess the risk of inaccuracies in user-entered or semi-automatically generated address components of map features.

### SUMMARY

In various embodiments, an assessment of risk of inaccuracies in address components of map features is performed. A geographic information system includes one or more databases comprising entries of map data. Each entry describes a map feature. Each map feature is indexed by location, and may include an address. Each address is composed of one or more address components, such as street, city, state, country, zip code, and the like. Users use client devices to view map data retrieved from the geographic information system by a geographic information server and to propose edits to the map data. Each proposed edit to the map data either proposes to add a new feature at a location or proposes to modify an existing map feature at a location. Based on the location of the edited map feature, potential address components for the map feature are automatically compiled and suggested to the user, from which the user can select address components, and some addess components are directly suggested by the user.

In one embodiment, all polygonal features containing the location or near the location of the selected map feature are identified as having potential matches for the address components of the map feature. Examples of polygonal map features include political territories such as districts, cities, states, and countries, as well as non-political areas such as malls, complexes, and campuses. The polygonal map features may represent an address component itself (e.g., the polygon of a city represents the city), or may have one or more address components designated for it, such as street, city, state, zip code, country, etc. The strength of the potential matches for the address of the map feature are identified. In one embodiment, for each identified polygonal feature, the error bounds of the polygon are modeled based on the quality of the boundary of the polygon. Then, the error bounds of the polygon are compared to the location of the selected map feature to determine the strength of the match. Address components corresponding to the identified polygonal features are suggested to the user to be components of the address of the selected map feature based on the strength of the matches.

In various embodiments, the quality of the boundary of a respective polygon may impact the risk of inaccuracy of an address component generated from the polygon. For example, a natural boundary of a polygon that conforms to a natural feature such as a major river may be higher quality and more trusted than a straight line segment of a political boundary that is a likely to be a lower quality approximation. Similarly, the precision of the boundary and the age of the boundary may be considered in determining the quality of the boundary.

In another embodiment, a combination of address components from an edited map feature are received. A risk of inaccuracy of the address is determined by comparison to other map data. Optionally, a confidence level of the determined risk may also be determined. The determined risk and optionally the determined confidence level may be adjusted based at least in part on the magnitude of an inconsistency between the combination of address components of the edited map feature. Subsequently, a treatment of the edited map feature can be selected based on the determined risk of the edited map feature. For example, the proposed edits assessed to be the lowest risk may be implemented whereas the proposed edits assessed to be higher risk may receive additional attention. For example, a warning message may be displayed or the proposed edit may be flagged for subsequent review by a moderator who reviews map edits for quality assurance. In some cases, if the proposed edit is assessed to be in excess of a threshold, the proposed edit may be rejected.

The features and advantages described in this summary and the following detailed description are not all-inclusive. Many additional features and advantages will be apparent to one of ordinary skill in the art in view of the drawings, specification, and claims hereof.

### BRIEF DESCRIPTION OF THE DRAWINGS

FIG. 1 is a high-level block diagram of a computing environment of a system in accordance with an embodiment of the invention.

FIG. 2 is a flow chart illustrating a method of generating suggested address components for an address of a selected map feature, in accordance with an embodiment.

FIG. 3 is an example illustration of indexing a polygonal feature based on the S2 cells that are covered by the polygonal feature, in accordance with an embodiment.

FIG. 4 is a flow chart illustrating a method of determining the strength of matches between a location of a selected map feature and identified polygonal features, in accordance with an embodiment.

FIG. 5 is a flow chart illustrating a method of assessing the risk of inaccuracy of an address of an edited map feature and a treatment of the edited map feature based on the assessed risk, in accordance with an embodiment.

One skilled in the art will readily recognize from the following discussion that alternative embodiments of the structures and methods illustrated herein may be employed without departing from the principles of the invention described herein.

### DETAILED DESCRIPTION OF THE EMBODIMENTS

### System Overview

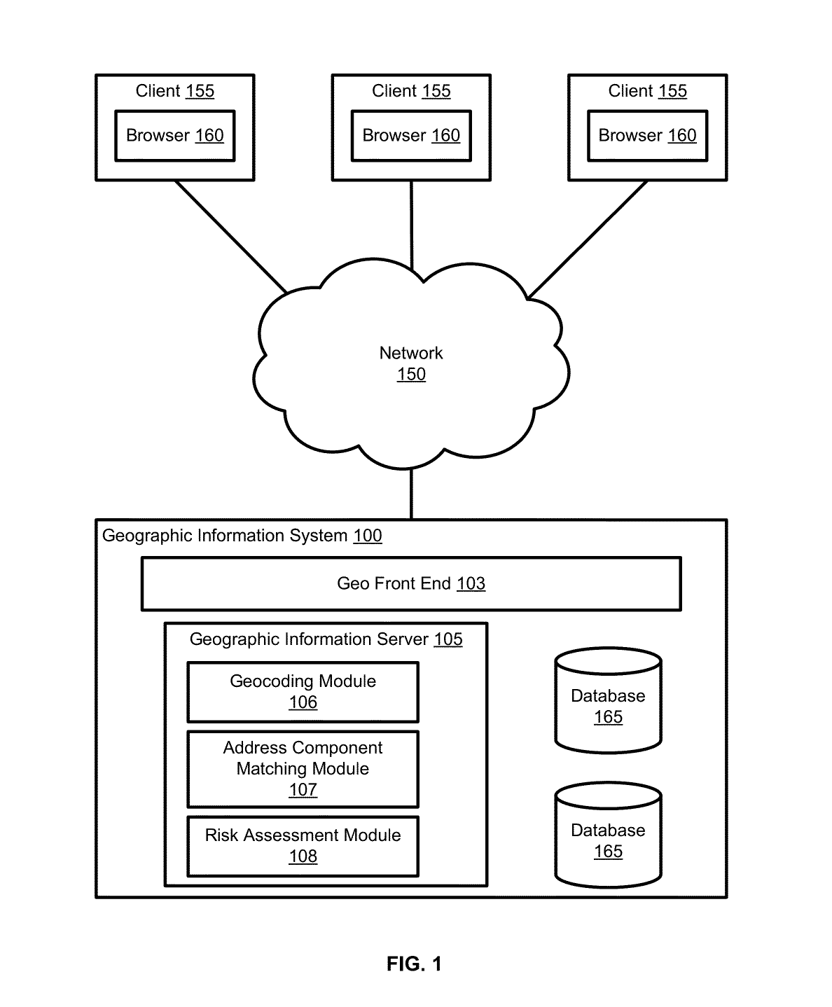

Embodiments of the invention provide an assessment of risk of inaccuracies in address components of map features that are edited by users. FIG. 1 is a high-level block diagram of a system environment in accordance with one embodiment. The system environment includes a plurality of clients 155 and a geographic information system 100 connected via a network 150, such as the Internet. Although three clients 155 are shown in FIG. 1 for clarity, in practice, many hundreds, thousands or more clients may be connected to the geographic information system 100 via the network 150.

A client 155 can be any user device such as a computer, a mobile device, or the like that is adapted to communicate with the geographic information system 100 over the network 150. Each client 155 is equipped with a browser 160 to view and edit map data retrieved from the geographic information system 100.

The geographic information system 100 includes at least one database 165, a geo front end 103, and at least one geographic information server 105. Although only two databases 165 are shown, in practice, there may be many databases or other data storage facilities that store data for the geographic information system 100. Likewise, a single geographic information server 105 is shown, but in practice, there may be many geographic information servers 105 in operation.

The databases 165 contain map data. Although the two databases 165 are shown as being internal to geographic information system 100, any type of data storage system, including local, remote, and distributed data storage systems can be used. Map data includes geographic data, such as latitude, longitude, elevation, location of geographic features of interest (e.g., bodies of water, mountains, forests); political data, such as country, state, and city boundaries; locations of roads and points of interest (e.g., government buildings, universities, stadiums), address numbering on streets; and attributes of features, such as whether an area is public and the nature of a surface of a street. The map data includes map features.

A map feature is one entry in a map database corresponding to an item on a map. The features of the map are generally represented by points, lines, or polygons. Examples of common map features include an intersection, a road, a landmark, a neighborhood, a park, a public transportation station, and a building. Examples of polygonal map features include political territories such as districts, cities, states, and countries, as well as non-political areas such as malls, complexes, and campuses. The polygonal map features may represent an address component itself (e.g., the polygon of a city represents the city), and may have one or more address components designated for it, such as street, city, state, zip code, country, etc.

Each map feature is indexed by location, and may include an address. Each address is composed of one or more address components, such as street, city, state, country, zip code, and the like. In some cases, some of the map data has been entered into the database 165 by users of the geographic information system 100. In one implementation, separate databases are maintained for data obtained through different sources. For example, one database may contain map data from a government source, and another database may contain data entered by users of the geographic information system 100. Some sources of data may be more authoritative than others. Accordingly, the source of the map data may also be stored with the map data, for example for use in moderating or curating the map data.

The geo front end 103 manages interactions between the clients 155 and the geographic information system 100. The geo front end 103 relays requests received from a client 155 to the geographic information server 105 and provides data retrieved from the databases 165 by the geographic information server 105 back to the client 155.

The geographic information server 105 serves map data from the databases 165 to clients 155. The geographic information server 105 includes a geocoding module 106, an address component matching module 107, and a risk assessment module 108.

The geocoding module 106 determines the geolocation (e.g., the latitude/longitude coordinates) of a map feature based on where it is drawn on the user's screen, and is one means for performing this function. In one implementation, the geocoding module 106 converts the x,y position on the user's screen relative to the origin of the view port to the corresponding latitude and longitude values. The geocoding module 106 may also perform reverse geocoding, which is to find all features that contain that latitude and longitude value. Embodiments of the invention provide improvements to the reverse geocoding process to generate address components of a map feature.

The address component matching module 107 determines the strength of a match between an address component of a polygonal feature covering the location of a selected map feature or near the location of a selected map feature, and is one means for performing this function. In one embodiment, the set of polygonal features can be filtered to include only those polygonal features that appear as address components, e.g. city, state, country and zip code. If the polygons for all of these features are precisely correct, it is expected to find exactly one feature of each type (i.e., one city, one state, one country, one zip code) for every point on the map. It is noted that political feature polygons are likely to have errors when they are created by crowdsourcing. For example, there are few visible markers in map data to indicate where the edge of a zip code area should be. Thus, it is likely that the edge indicated by a user is merely approximate. On the other hand, where a political feature is known to have a border that is visible on satellite imagery (e.g., a river that separates two states), it is likely that that portion of the political feature's boundary is accurate because the map data provides users a reference to draw the polygon. If the polygons are not precisely correct, there may be locations covered by more than one city feature, for example.

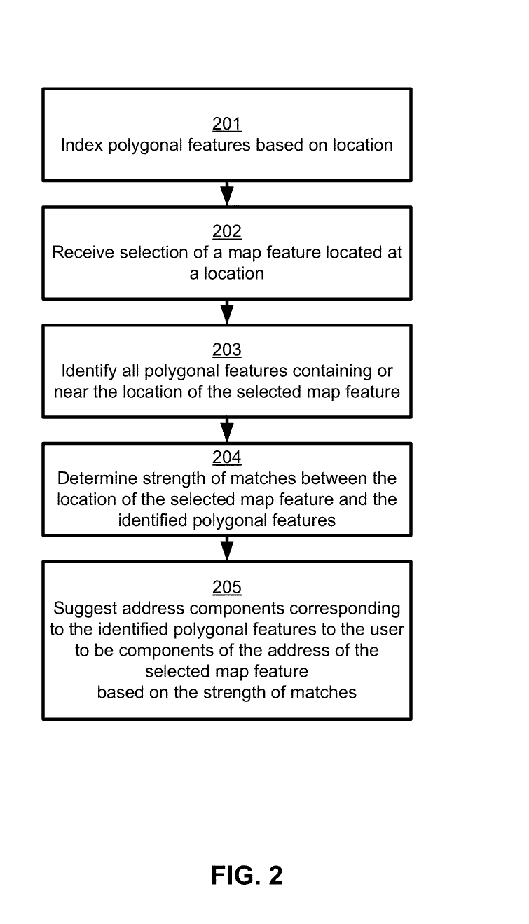

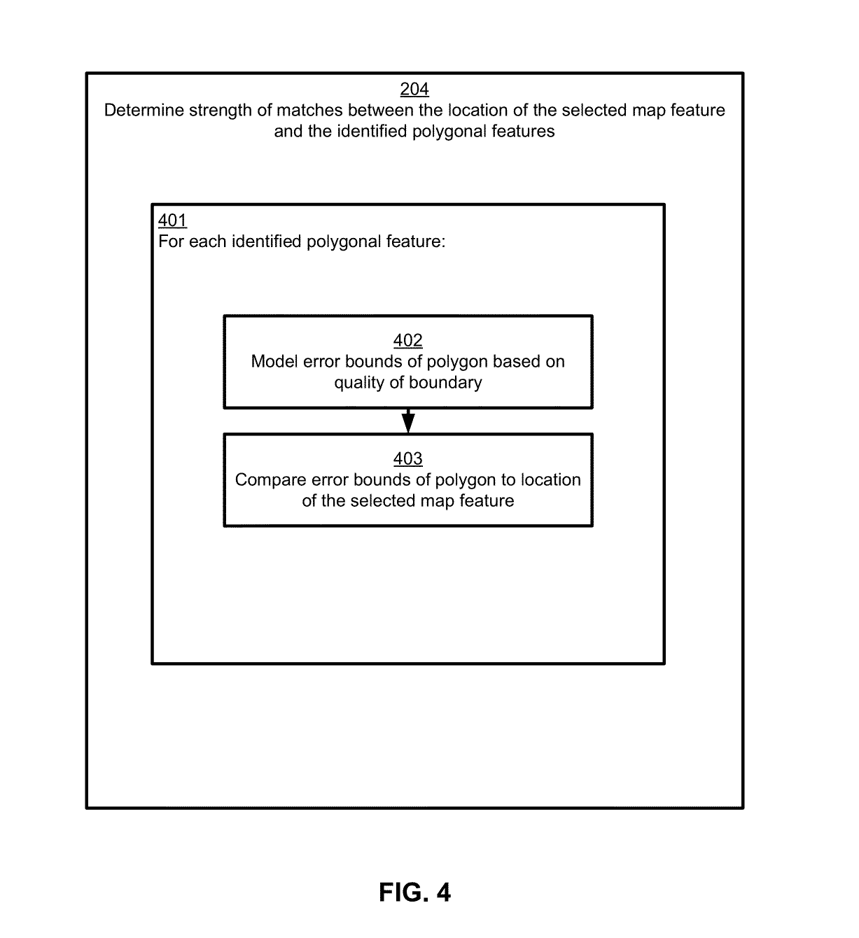

The strength of a match determined by the address component matching module 107 can be used to determine which options to suggest to a user as possible options for an address component of an edited or added feature to the map data. Techniques for determining suggested address components based on the strength of matches are described below with reference to FIGS. 2 and 4.

The risk assessment module 108 of the geographic information server 105 assigns a risk to a proposed edit to the map data, based at least in part on the strength of a match used for an address component, and is one means for performing this function. As will be described in greater detail below, if a selection of an address component by a user is not a strong match, the edit to the map feature is marked as being a higher risk of containing an error. Likewise, if a combination of address components selected by a user suggests an inconsistency as compared to other map data, the edit may be marked as being higher risk. Accordingly, an edit to a map feature marked as higher risk may receive more scrutiny than an edit to map feature marked as lower risk.

### Semi-Automatic Address Component Generation

FIG. 2 is a flow chart illustrating a method of suggesting address components for an address of a selected map feature, in accordance with an embodiment. As a preliminary step, polygonal features of the map are indexed 201 based on location. Thus, for any location on a map, it can be quickly determined which polygonal features include or are near the location.

To establish the index, in one embodiment, the entire geographic area described by the geographic information system 100 is divided into cells, each of which represents a portion of the geographic area. At the lowest zoom level, level 1, the entire geographic area is divided into a small number of cells, for example six cells, each representing a relatively large area. At the next zoom level, level 2, the area of each cell from level 1 is divided into four smaller cells, each covering ¼^{th} of the area of a level 1 cell. This regular sub-division, whereby each cell is sub-divided into four smaller cells is repeated for a predetermined number of levels, forming a hierarchy of levels. This hierarchy of cells is similar to a quad-tree arrangement. This organization recursively divides each cell of a given level of detail (the parent) into 4 cells (the children) at the next highest level of detail, each of which cover approximately ¼ the area of the parent cell. In one embodiment, there are six square map portions at a first level covering the entire surface of the Earth, and there are 21 additional zoom levels resulting in approximately 2.64×10¹³ cells at level 22, which are each approximately 4.4 m².

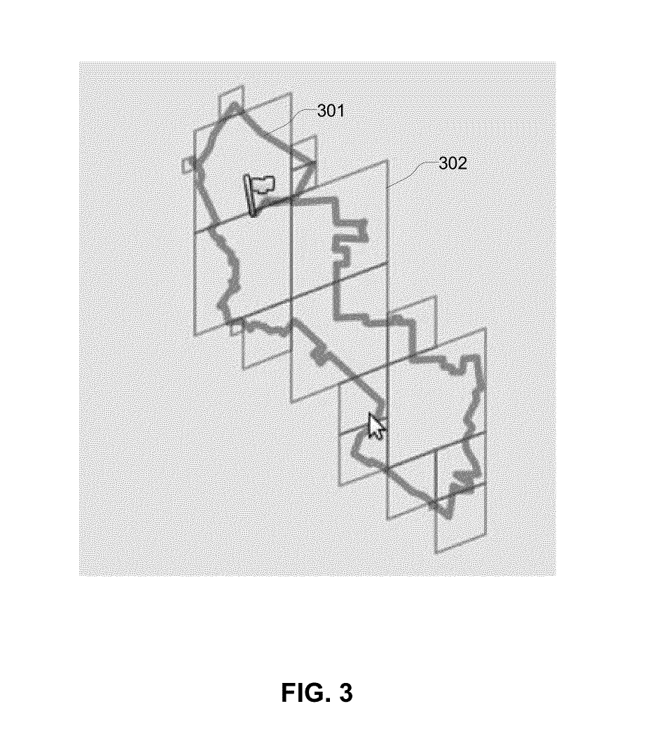

Accordingly, in this hierarchy of cells, every polygon can be indexed based on the cells which are covered by the polygon. In one embodiment, every cell is included that encompasses a boundary of the polygon. An example of an indexed polygonal feature 301, showing the cells 302 that cover the polygon is shown in FIG. 3. In one implementation, a range of zoom levels is used to compute a covering of the polygonal feature, for example levels 16 through 12, and a maximum number of cells is also established for the covering, for example 40 cells. Then, the cells are found that approximate the entire polygon as tightly as possible such that there are no cells smaller than level 16 and no cells larger than level 12. For example, the cells 302 that cover the polygon shown in FIG. 3 have 5 different cell sizes (i.e., from 5 different zoom levels). Also, if each cell that is shown in the picture is subdivided into its four children, in most cases some part of the polygon will overlap each of the four children, so it would not be possible to pick a tighter covering of the polygon that included three out of the four children. In some cases, even if it were to be possible to obtain a tighter covering of the polygon by including three out of the four children, the single parent cell may still be used instead of the three children because of the a limit on the total number of cells, for example not to exceed 40 cells. As a result, the covering is merely an approximation of the polygon. There is a tradeoff between efficiency in terms of the number of cells needed to cover the polygon and the precision with which the polygon is covered.

Referring again to FIG. 2, a selection of a map feature located at a location is received 202. A user may make a selection in connection with proposing a new map feature or an edit to an existing map feature. In either case, the location of the selected feature is received from the user's input or interpreted by the geocoding module 106 of the geographic information server 105.

Once the location of the selected map feature is known, all polygonal features containing or near the location of the selected map feature are identified 203. Recall that the polygonal features were indexed based on location, for example, based on the cells that are covered by the polygon. In one implementation, a query is executed for all polygonal features indexed for the cells at any level that contain or are near the location of the selected map feature. In another implementation, only cells between certain levels, for example levels 12 to 16, are considered. In this case, the levels chosen for indexing the polygons are the same levels chosen for querying for polygonal features, and the range of levels is selected for efficiency for both large and small polygons. The results of this query are referred to herein as the matching polygonal features for the location of the selected map feature. At least one matching polygonal feature is identified 203 in order to proceed with the method.

After the polygonal features containing or near the location of the selected map feature are identified 203, the strength of the matches between the location of the selected map feature and the identified polygonal features are determined. In one implementation, a match is deemed stronger if the location of the selected map feature is contained in the polygon of the matching polygonal feature, and a match is deemed weaker if the location of the selected map feature is not contained in the polygon but is merely close to it. More detail regarding determining the strength of matches to the identified polygonal features is included below with reference to FIG. 4.

Lastly, address components corresponding to the identified polygonal features are suggested 205 to the user to be components of the address of the selected map feature based on the strength of the matches. The suggestions may be presented, for example, in a populated drop down box from which a user can select the appropriate polygonal feature. In one embodiment, the address component options for each component are presented in order based on the strength of the match, with one or more strong matches presented first.

FIG. 4 is a flow chart illustrating a method of determining 204 the strength of matches between the location of the selected map feature and the identified polygonal features, in accordance with an embodiment. The following method is iterated for each matching polygonal feature 401 identified 203 as containing or near the location of the selected map feature. For each matching polygonal feature 401, the error bounds of the polygon are modeled 402 based on the quality of the boundary. The error bounds represent a distance or margin of error on either side of the marked boundary of a polygon such that it is expected to some predetermined level of confidence that the true boundary of the polygon lies within the distance or margin. This can be performed, for example, by the risk assessment module 108 of the geographic information system 100.

The risk assessment module 108 can model the error bounds of a polygon based on known models of imperfection and known error bounds stemming from the source of the polygonal feature. For example, the satellite imagery may have known limitations in terms of resolution that leads to a known error bound for certain types of boundaries. In cases where error bounds are not known a priori from the source of the data, the error bounds can be modeled based on the quality of the boundary as determined from several characteristics of the boundary:
Conformance to Natural Features. Many political boundaries conform to natural features. For example, hills, rivers, water bodies, and in urban areas road centerlines, etc., can be used to determine appropriate error bounds for a polygon that conforms to natural features. The degree to which a boundary conforms to a natural feature present on the map leads to narrower error bounds because it is more likely to be accurately represented on the map, and is consequently more likely to be at lower risk for inaccuracies. In one embodiment, to determine if a boundary conforms to a natural feature, the dot product of the vectors between the two features is determined, and a small value indicates conformance, and the quality of the boundary is a function of the dot product. In some cases, the use of snapping algorithms can be used to determine, if with small perturbations, any inconsistencies between the natural feature and the polygon boundary are eliminated.
Discretization Precision. More detailed boundaries are generally modeled to have lower error bounds than less detailed boundaries. When no obvious natural or manmade features is nearby and approximately fits, then long straight lines in a boundary can be an indication for poor quality. Especially for country and state boundaries which are not near any natural feature, the boundaries are sometimes represented coarsely (e.g., in increments of 1, 10, or 100 km). When the vertices or angles show abrupt qualities, it can be assumed and modeled that errors below the detected level of coarseness or in that magnitude are reasonable as the boundary in question is uncertain to that quantum of measurement. Thus, the higher the coarseness of the polygon boundary, the greater the error bounds are to accommodate the level of discretization error that may be present.
Age. Older boundaries that have been used and reviewed over time are likely to be more accurate than newly drawn boundaries. Thus, the older boundaries may be modeled with lower error bounds than newly drawn boundaries. The error bounds may also be modeled to narrow over time in some implementations.

After the error bounds of the polygon are modeled 402 based on the quality of the boundary, the error bounds of the polygon are compared 403 to the location of the selected map feature to determine the strength of the match between the identified polygonal feature and the location of the selected map feature. To make this assessment, it is noted that the location of the selected map feature also has a degree of imprecision due to a visual mistake or measurement imperfection that can be accommodated in the follow process. Generally, if the location of the selected map feature is inside of the polygonal feature, then it is a stronger match for the selected map feature 202 than if the location of the selected map feature is not inside the polygonal feature. A match deemed to be “weak” is an indication of how likely it is that the address components corresponding to the weakly matching polygon are the proper address components of the map feature selected by the user. A strong match is more likely to generate the proper address component of the map feature selected by the user as compared to a weaker match.

In one embodiment, through the comparison of error bounds of the polygon to the location of the selected map feature (in view of the likely imprecision), the strength of the match can be determined on a spectrum from strong to weak. In the case that the location of the selected map feature is inside the polygon, and not within the margin of error of the boundary (e.g., error bounds for a particular confidence interval described above), there is a lower risk that the address components corresponding to the polygon are inaccurate for the feature than if the selected map feature were located inside the polygon and within the margin of error. In other words, if the location of the map feature is inside the polygon but within the margin of error, there is a higher probability that the location of the map feature is actually outside the true boundary of the polygon. Similarly, if the location of the selected map feature is outside of polygon, but within the margin of error of the boundary, there is a lower risk that the address components corresponding to the polygon are inaccurate for the feature than if the location of the selected map feature is outside of the polygon and not within the margin of error. The farther the location of the map feature is outside of the boundary of the polygon, the higher the risk that address components generated from the polygon are inaccurate for the map feature.

### Assessing Risk of Inaccuracy of Addresses

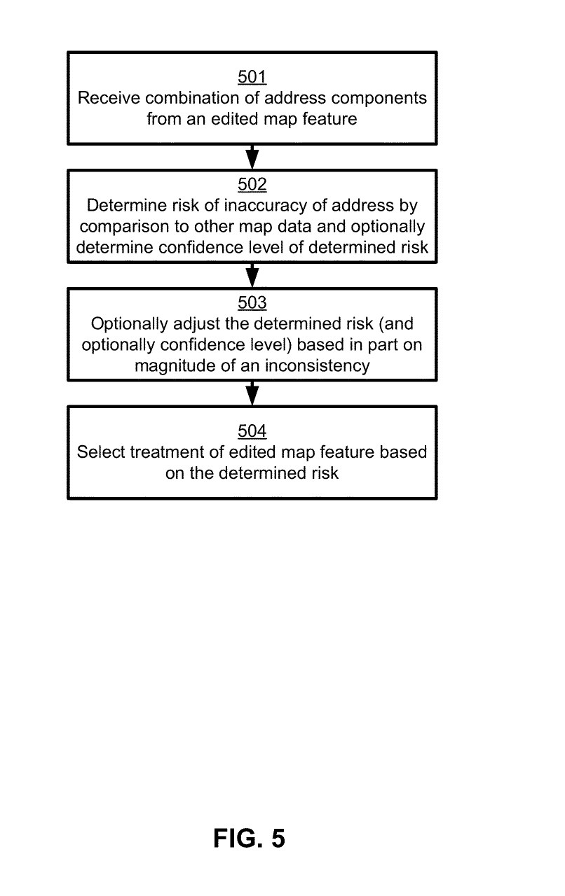

FIG. 5 is a flow chart illustrating a method of assessing the risk of inaccuracy of an address of an edited map feature and a treatment of the edited map feature based on the assessed risk, in accordance with an embodiment. The risk of inaccuracy refers to the probability that the proposed address of the edited map feature is not the true address.

The method begins with receiving 501 a combination of address components from an edited map feature. The address components may be, for example, a combination of two or more of the following address components: country, state/province, county, city, locality, sublocality, street, and building. The address components may be those semi-automatically generated and suggested to a user according to the method described above with reference to FIGS. 2 and 4, or they may be selected by a user without the aid of the above methods, or they may be obtained from another data source.

Regardless of the source of the combination of address components, the risk of inaccuracy of an address can be determined 502 at least in part by comparison to other map data. By comparison to other map data, it may be determined whether a certain combination of particular address components is acceptable or risky. In one implementation, for example, if many other instances of the same combination of address components are found within the existing map data, it may be assumed that the combination of address components is low risk, whereas if the same combination of address components is rarely found or not found, it may be assumed that the combination of address components is higher risk. Also, if it is found that a certain first combination of address components is commonly changed upon subsequent review to second combination of address components, the first combination of address components can be determined to be high risk.

Alternatively or additionally, rules may be established for combinations of components that indicate an inconsistency and thus increase the risk of inaccuracy, by comparison to other map data. Rules may particularly be established for address component combinations of different levels of address components that normally have a containment relationship, such as city and county; city and state; and state and country. The containment relationship implies that all addresses that share the lower level address component (such as state) also share a common higher level address component (such as country). For example, the presence of a combination of a building from a building address component and a street from a street address component when the building is not located on the street is indicative of an inconsistency that increases the risk of inaccuracy. In other words, where an inconsistency exists in a containment relationship between two address components in the combination, the risk of an inaccuracy is increased. As another example, if City A lies entirely within County X, an address component combination that includes City A and any other county besides County X increases the risk of inaccuracy.

Moreover, a confidence level of a determined risk can optionally also be determined. The confidence level can be determined from the error bounds of the polygons representing the address components based on the uncertainty models and probabilities known or inferred from the map data, as discussed above. In some embodiments, techniques of spatial uncertainty modeling or sensor fusion can be used to determine a confidence level as known to those of skill in the art.

It is noted that the risk of inaccuracies of address combinations depends on distance, but the risk is inherently non-linear with respect to distance. For example, an address located slightly away the border of a town referring to the town may be low risk, but the risk may increase more than linearly with respect to how far away the address is located from the border of the town. Thus, in one embodiment, modeling the risk of inaccuracies based on non-linear algorithms rather than solely on discrete rules is preferred to capture the probability that an edited address in inaccurate. Solely rule-based solutions are unlikely to work well in a data set that is imperfect and evolving, such as a data set of map features that are edited by a plurality of users.

In one embodiment, conditional probability is used to model what combinations of address components are inconsistent. In one implementation, the existing map data is used as the prior address body. The conditional probability that a combination of address components is valid varies by its location. For example, a row of stores or houses on a street might have a strange combination of address components that may normally raise risk, but using this prior body of addresses, the risk can be lowered or eliminated. Similarly, automatic generation of address components can also use this body of nearby addresses to infer the proper way to represent an address in that location. Thus, distances are relevant in this conditional probability framework. In some cases, it is beneficial to compute the conditional probability of combinations on the fly or pre-compute them by region, given the dependence on location. Various approaches may be used, such as tagging all addresses with inconsistent components, extracting k-nearest neighbors that are inconsistent, and getting total number of nearby addresses. Then, statistically priors can be computed that a particular inconsistency is valid. The prior probability can be used to determine the risk of the combination. In some cases, models of accidental inconsistency in view of the fact that borders are imperfectly drawn can be used to modulate the priors—again based on uncertainty models to infer the innocuousness of an accidental inconsistency.

Optionally, the determined risk can be adjusted 503 based in part on the magnitude of the inconsistency between the address components. For example, if the magnitude of the inconsistency is large, the risk can be increased, whereas if the magnitude of the inconsistency is small, the risk can be decreased. The magnitude of the inconsistency can also be determined based on the size of the area and/or population or rank or other prominence signals corresponding to the address component, such as in the case of a city mismatch with a country, based on the size and/or population of the city. In some cases, the scale can be a log scale. Further optionally, the probability of accidental inconsistency can also be determined and used to adjust 503 the determined risk. If the likelihood of accidental inconsistency is high, meaning that it only appears that the address components are inconsistent to a small degree (e.g., to a degree that can be explained within the error bounds of polygons representing the respective address components), the risk of inaccuracy can be adjusted lower. Likewise, optionally, the confidence level in the determined risk of inaccuracy can be adjusted based on the magnitude of the inconsistency. For example, if the magnitude of the inconsistency is high, it can increase the confidence level of the risk. If the magnitude of the inconsistency is low, it can decrease the confidence level of the risk.

The treatment of an edited map feature is selected 504 based on the determined risk. Examples of treatments include accepting the edit, displaying a warning message, flagging the edit for review by a moderator, and rejecting the edit. One or more of these treatment options may be taken for any edit. For example, an edit with a moderate risk may be accepted from a highly trusted user and still flagged for review by a moderator post-facto. When a risk is very high and the confidence in the risk value is also high, an edit may be rejected without subsequent review. In general, for edits with risk assessments lower on the spectrum than those which can be rejected without subsequent review, lower risk edits require less attention than higher risk edits. Higher risk edits may receive special attention from one or more moderators who review map edits for quality assurance. The special attention may include additional processing, such as a higher level scrutiny by one or more moderators before the edit is approved. By rejecting very high risk edits and paying special attention to other risky edits, the propagation of errors in the map data is less likely. Thus, individual contributors can operate largely independently to enhance to comprehensiveness of the map data, and the quality of the map data does not suffer as a result.

### Additional Configuration Considerations

The present invention has been described in particular detail with respect to several possible embodiments. Those of skill in the art will appreciate that the invention may be practiced in other embodiments. First, the particular naming of the components, capitalization of terms, the attributes, data structures, or any other programming or structural aspect is not mandatory or significant, and the mechanisms that implement the invention or its features may have different names, formats, or protocols. Further, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead performed by a single component.

Some portions of above description present the features of the present invention in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times, to refer to these arrangements of operations as modules or by functional names, without loss of generality.

Unless specifically stated otherwise as apparent from the above discussion, it is appreciated that throughout the description, discussions utilizing terms such as “determining” or the like, refer to the action and processes of a computer system, or similar electronic computing device, that manipulates and transforms data represented as physical (electronic) quantities within the computer system memories or registers or other such information storage, transmission or display devices.

Certain aspects of the present invention include process steps and instructions described herein in the form of an algorithm. It should be noted that the process steps and instructions of the present invention could be embodied in software, firmware or hardware, and when embodied in software, could be downloaded to reside on and be operated from different platforms used by real time network operating systems.

The present invention also relates to an apparatus for performing the operations herein. This apparatus may be specially constructed for the required purposes, or it may comprise a general-purpose computer selectively activated or reconfigured by a computer program stored on a computer readable medium that can be accessed by the computer and run by a computer processor. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

In addition, the present invention is not limited to any particular programming language. It is appreciated that a variety of programming languages may be used to implement the teachings of the present invention as described herein, and any references to specific languages are provided for enablement and best mode of the present invention.

The present invention is well suited to a wide variety of computer network systems over numerous topologies. Within this field, the configuration and management of large networks comprise storage devices and computers that are communicatively coupled to dissimilar computers and storage devices over a network, such as the Internet.

Finally, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention.

1. A method of generating address components for an address of a selected map feature, the method comprising:
receiving a selection of a map feature located at a location;
identifying at least one polygonal feature containing or near the location of the selected map feature;
for an identified polygonal feature, determining a strength of a match between the location of the selected map feature and the identified polygonal feature based on a quality of a boundary of the identified polygonal feature; and
generating one or more address components for the map feature from the at least one identified polygonal feature based on the strength of the match.

2. The method of claim 1, wherein determining a strength of a match between the location of the selected map feature and the identified polygonal feature based on the quality of the boundary of the identified polygonal feature comprises:
modeling error bounds of a polygon based on the quality of the boundary; and
comparing the error bounds of the polygon to the location of the selected map feature.

3. The method of claim 2, wherein the quality of a boundary is determined based at least in part on conformance to a natural feature.

4. The method of claim 2, wherein the quality of a boundary is determined based at least in part on discretization precision.

5. The method of claim 2, wherein the quality of a boundary is based at least in part on age of the boundary.

6. The method of claim 2, wherein the error bounds comprise a distance margin of error of a marked boundary of a polygon for a predetermined level of confidence that a true boundary of the polygon lines within the distance.

7. The method of claim 2, wherein the strength of the match is determined on a spectrum from strong to weak, wherein the strongest matches are where the location of the selected map feature is within the identified polygon and not within the error bounds.

8.-15. (canceled)

16. A computer program product comprising a non-transitory computer-readable storage medium containing computer program code for generating address components for an address of a selected map feature, the code for:
receiving a selection of a map feature located at a location;
identifying at least one polygonal feature containing or near the location of the selected map feature;
for an identified polygonal feature, determining a strength of a match between the location of the selected map feature and the identified polygonal feature based on a quality of a boundary of the identified polygonal feature; and
generating one or more address components for the map feature from the at least one identified polygonal feature based on the strength of the match.

17. The computer program product of claim 16, wherein determining a strength of a match between the location of the selected map feature and the identified polygonal feature based on the quality of the boundary of the identified polygonal feature comprises:
modeling error bounds of a polygon based on the quality of the boundary; and
comparing the error bounds of the polygon to the location of the selected map feature.

18. The computer program product of claim 17, wherein the quality of a boundary is determined based at least in part on conformance to a natural feature.

19. The computer program product of claim 17, wherein the quality of a boundary is determined based at least in part on discretization precision.

20. The computer program product of claim 17, wherein the quality of a boundary is based at least in part on age of the boundary.

21. The computer program product of claim 17, wherein the error bounds comprise a distance margin of error of a marked boundary of a polygon for a predetermined level of confidence that a true boundary of the polygon lines within the distance.

22. The computer program product of claim 17, wherein the strength of the match is determined on a spectrum from strong to weak, wherein the strongest matches are where the location of the selected map feature is within the identified polygon and not within the error bounds.

23.-30. (canceled)

31. A computer system for generating address components for an address of a selected map feature, comprising:
a processor for executing computer program code; and
a non-transitory computer-readable storage medium containing computer program code executable to perform steps comprising:
receiving a selection of a map feature located at a location;
identifying at least one polygonal feature containing or near the location of the selected map feature;
for an identified polygonal feature, determining a strength of a match between the location of the selected map feature and the identified polygonal feature based on a quality of a boundary of the identified polygonal feature; and
generating one or more address components for the map feature from the at least one identified polygonal feature based on the strength of the match.

32. The computer system of claim 31, wherein determining a strength of a match between the location of the selected map feature and the identified polygonal feature based on the quality of the boundary of the identified polygonal feature comprises:
modeling error bounds of a polygon based on the quality of the boundary; and
comparing the error bounds of the polygon to the location of the selected map feature.

33. The computer system of claim 32, wherein the quality of a boundary is determined based at least in part on conformance to a natural feature.

34. The computer system of claim 32, wherein the quality of a boundary is determined based at least in part on discretization precision.

35. The computer system of claim 32, wherein the quality of a boundary is based at least in part on age of the boundary.

36. The computer system of claim 32, wherein the error bounds comprise a distance margin of error of a marked boundary of a polygon for a predetermined level of confidence that a true boundary of the polygon lines within the distance.

37. The computer system of claim 32, wherein the strength of the match is determined on a spectrum from strong to weak, wherein the strongest matches are where the location of the selected map feature is within the identified polygon and not within the error bounds.
